(19) United States
(12) Patent Application Publication
(10) Pub. No.: US 2024/0398636 A1
(43) Pub. Date: Dec. 5, 2024

(54) AUTONOMOUS UNIVERSAL WHEELCHAIR SECUREMENT DEVICE FOR WHEELCHAIR ACCESSIBLE AUTONOMOUS VEHICLES

(71) Applicant: The Braun Corporation, Winamac, IN (US)

(72) Inventors: Timothy G. Schwarz, Delafield, WI (US); Larry Dean Michels, Olney, IL (US); Mark Pettigrew, Mount Carmel, IL (US)

(21) Appl. No.: 18/733,203

(22) Filed: Jun. 4, 2024

Related U.S. Application Data
(60) Provisional application No. 63/506,255, filed on Jun. 5, 2023.

(51) Int. Cl. A61G 3/08

(52) U.S. Cl. CPC A61G 3/0808

(57) ABSTRACT

A wheelchair securement system for a vehicle is provided, comprising a latch configured to grasp an axle of a wheelchair, actuators operatively coupled to the latch; and a controller configured to generate control signals that control movement of the actuators to place the latch in an operative position before the wheelchair enters the vehicle, the operative position comprising a location where the axle of the wheelchair can be grasped securely. Further, A method for securing a wheelchair in a vehicle is provided, the method comprising receiving wheelchair settings of a wheelchair to be secured in a vehicle, generating control signals according to the wheelchair settings, and communicating the control signals to an actuator of a wheelchair restraint, wherein the actuator moves the wheelchair restraint to secure the wheelchair according to the control signals.

### FIELD OF THE DISCLOSURE

The present disclosure relates generally to wheelchair accessible autonomous vehicles and, more specifically, to an autonomous universal wheelchair securement device for wheelchair accessible autonomous vehicles

### BACKGROUND

Autonomous vehicles (AVs) can drive themselves using a variety of sensors and in-vehicle technologies In such AVs, there is typically no human operator who drives or otherwise controls the vehicle Such AVs may be used for a variety of purposes, including for autonomous delivery of items such as groceries and food to recipients, and for ride-sharing, for example, similar to a taxi service Some AVs may be configured to be wheelchair accessible Wheelchair accessible vehicles generally available in the marketplace are of two types: a first type allows for configuration of the vehicle to secure a particular wheelchair make and model; the second type allows for securement of a wide variety of wheelchairs but requires manual adjustment of the securement device according to the specific wheelchair make and model of a particular passenger The first type is usually found in private vehicles; the second type is typically used in public vehicles, such as buses and ride-share vans

### BRIEF DESCRIPTION OF DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates an actuated unoccupied wheelchair restraint (AUWR) according to some embodiments of the present disclosure;

FIGS. 2A-2D illustrate various views of the AUWR showing example actuators in operation according to some embodiments of the present disclosure;

FIG. 3 illustrates the AUWR latched to an unoccupied wheelchair according to some embodiments of the present disclosure;

FIG. 4 illustrates an example occupied wheelchair restraint (OWR) according to some embodiments of the present disclosure;

FIG. 5 illustrates an example configuration of the AUWR and OWR with a wheelchair in an AV according to some embodiments of the present disclosure;

FIG. 6 illustrates the example configuration of the AUWR and OWR alongside a transfer seat in an example AV according to some embodiments of the present disclosure;

FIG. 7 illustrates an example configuration of seats in an AV fitted with the AUWR and OWR according to some embodiments of the present disclosure;

FIGS. 8A and 8B illustrate example phone application and remote control used in conjunction with the autonomous wheelchair securement device according to some embodiments of the present disclosure;

FIG. 9 is a block diagram of a control system used for the autonomous wheelchair securement device in an AV according to some embodiments of the present disclosure;

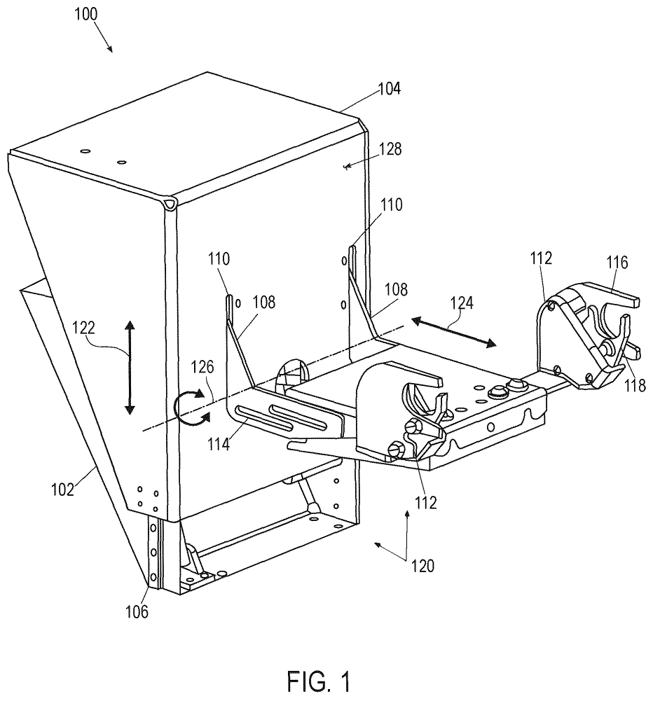

FIG. 1 is a flowchart of an example process for implementing and operating a securement device in an AV according to some embodiments of the present disclosure;

FIG. 11 is a flowchart of another example process for implementing and operating a securement device in an AV according to some embodiments of the present disclosure; and

FIG. 12 is a flowchart of yet another example process for implementing and operating a securement device in an AV according to some embodiments of the present disclosure

### DETAILED DESCRIPTION OF THE EMBODIMENTS

### Overview

The systems, methods, and devices of this disclosure each have several innovative aspects, no single one of which is solely responsible for all of the desirable attributes disclosed herein Details of one or more implementations of the subject matter described in this Specification are set forth in the description below and the accompanying drawings

When a passenger brings their wheelchair with them in an AV functioning as a ride-share vehicle, the wheelchair needs to be secured so that it cannot move around during transit or in the event of a crash Wheelchair securement devices exist, but as mentioned previously, they are either fixed in their compatibility to a particular wheelchair make and model, or else require manual adjustment to secure a particular wheelchair In an AV used for general ride-share in a manner similar to a public transport vehicle, neither of these approaches works well because of the wide variety of wheelchairs that potential passengers can bring to the ride-share AV, and the lack of a human operator in the vehicle to assist with securement or to adjust the securement system between riders

As described herein, an AV is equipped with a securement system that comprises several elements A first element comprises an AUWR having latches to capture the axle of rigid manual wheelchairs Unlike a manual AUWR, the positions of the latches are not adjusted by hand using tools to match the dimensions of the wheelchair; instead, electrical actuators may control movement of the latches enabling them to automatically adjust positions to match any model and make of manual wheelchairs A second element comprises an OWR that may allow an occupied wheelchair with a compatible adapter to dock into the OWR securely A third element of the securement system comprises a transfer seat base (TSB) that may allow a wheelchair occupant to transfer to a seat adjusted and positioned appropriately alongside the secured wheelchair A fourth element of the securement system comprises controllers with associated software and/or hardware to allow pre-configuration of the system for a particular wheelchair according to a passenger's specifications Other elements are described further in reference to the corresponding figures as applicable

Embodiments of the present disclosure provide a wheelchair securement system comprising: a first wheelchair restraint including a latch configured to grasp an axle of a wheelchair; a second wheelchair restraint including a mechanism to securely couple with an adapter on the wheelchair; and a controller configured to select from among one of three selections: a first mode of securing the wheelchair with the first wheelchair restraint alone; a second mode of securing the wheelchair with the second wheelchair restraint alone; and a third mode of securing the wheelchair using both the first wheelchair restraint and the second wheelchair restraint

Embodiments further include a wheelchair restraint for a vehicle comprising: a bottom chassis securely fastened to a floor of the vehicle; a top chassis configured to slide up and down relative to the bottom chassis; an arm configured to rotate around a pivot axis at a first end proximate to the top chassis; a latch configured to securely grasp an axle of a wheelchair, the latch being attached to a second end of the arm distant from the top chassis and configured to slide relative to the arm toward and away from the top chassis; a first actuator configured to slide the top chassis relative to the bottom chassis; a second actuator configured to rotate the arm around the pivot axis; and a third actuator configured to slide the latch relative to the arm

Embodiments further include a controller for a wheelchair securement system, the controller comprising: a memory configured to store preset configuration settings of a wheelchair; and a processor configured to generate a set of instructions for an actuator of a wheelchair restraint in an AV The wheelchair restraint is configured to secure the wheelchair during motion of the AV

As will be appreciated by one skilled in the art, aspects of the present disclosure, in particular aspects of wheelchair securement systems for AVs, described herein, may be embodied in various manners (eg, as a method, a system, an AV, a computer program product, or a computer-readable storage medium) Accordingly, aspects of the present disclosure may take the form of an entirely hardware embodiment, an entirely software embodiment (including firmware, resident software, micro-code, etc) or an embodiment combining software and hardware aspects that may all generally be referred to herein as a “circuit,” “module” or “system” Functions described in this disclosure may be implemented as an algorithm executed by one or more hardware processing units, eg one or more microprocessors, of one or more computers In various embodiments, different steps and portions of the steps of each of the methods described herein may be performed by different processing units Furthermore, aspects of the present disclosure may take the form of a computer program product embodied in one or more computer-readable medium(s), preferably non-transitory, having computer-readable program code embodied, eg, stored, thereon In various embodiments, such a computer program may, for example, be downloaded (updated) to the existing devices and systems (eg to the existing perception system devices and/or their controllers, etc) or be stored upon manufacturing of these devices and systems

The following detailed description presents various descriptions of specific certain embodiments However, the innovations described herein can be embodied in a multitude of different ways, for example, as defined and covered by the claims and/or select examples In the following description, reference is made to the drawings, in which like reference numerals can indicate identical or functionally similar elements It will be understood that elements illustrated in the drawings are not necessarily drawn to scale Moreover, it will be understood that certain embodiments can include more elements than illustrated in a drawing and/or a subset of the elements illustrated in a drawing Further, some embodiments can incorporate any suitable combination of features from two or more drawings

The following disclosure describes various illustrative embodiments and examples for implementing the features and functionality of the present disclosure While particular components, arrangements, and/or features are described below in connection with various example embodiments, these are merely examples used to simplify the present disclosure and are not intended to be limiting It will of course be appreciated that in the development of any actual embodiment, numerous implementation-specific decisions must be made to achieve the developer's specific goals, including compliance with system, business, and/or legal constraints, which may vary from one implementation to another Moreover, it will be appreciated that, while such a development effort might be complex and time-consuming; it would nevertheless be a routine undertaking for those of ordinary skill in the art having the benefit of this disclosure

In the Specification, reference may be made to the spatial relationships between various components and to the spatial orientation of various aspects of components as depicted in the attached drawings However, as will be recognized by those skilled in the art after a complete reading of the present disclosure, the devices, components, members, apparatuses, etc described herein may be positioned in any desired orientation Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction When used to describe a range of dimensions or other characteristics (eg, time, pressure, temperature, length, width, etc) of an element, operations, and/or conditions, the phrase “between X and Y” represents a range that includes X and Y

As described herein, one aspect of the present technology is the gathering and use of data available from various sources to improve quality and experience The present disclosure contemplates that in some instances, this gathered data may include personal information The present disclosure contemplates that the entities involved with such personal information respect and value privacy policies and practices

Other features and advantages of the disclosure will be apparent from the following description and the claims

### EXAMPLE EMBODIMENTS

FIG. 1 is a diagram illustrating an AUWR 1 according to some embodiments of the present disclosure AUWR 1 comprises a bottom chassis 12 and a top chassis 14 configured to slide using a sliding mechanism 16 In the embodiment shown, sliding mechanism 16 comprises rails affixed to bottom chassis 12 and a mating member (not shown) affixed to top chassis 14 that permits sliding along the rails In some embodiments, sliding mechanism 16 may comprise pins and slots, for example, with the slots provided in top chassis 14 and pins in bottom chassis 12 or vice versa, the pins sliding through the slots suitably Any other mechanism that enables top chassis 14 to slide relative to bottom chassis 12 without separating therefrom may be encompassed in sliding mechanism 16 within the broad scope of the embodiments of the present disclosure

Further, bottom chassis 12 and top chassis 14 may be of any suitable shape appropriate for their respective functions The shapes shown in the figure are merely for illustrative purposes and are not to be construed as limitations The shapes may vary according to the chassis and/or frame of the AV to which AUWR 1 is attached, forces acting on AUWR 1 during operation and transit and other considerations beyond the scope of the present disclosure

AUWR 1 further comprises one or more arms, such as arm 18, protruding through corresponding slots, such as slot 11 In the example embodiment, two of arm 18 are shown with corresponding two of slot 11 Any number of arms may be used within the broad scope of the embodiments Arm 18 is affixed to a latch 112 at its free end distant from top chassis 14 Latch 112 may slide along arm 18 using a sliding mechanism 114 In the embodiment shown, sliding mechanism 114 comprises pins and slots In other embodiments, sliding mechanism 114 may comprise rails Any suitable mechanism that allows latch 112 to slide forward and backward (ie, away from top chassis 14 and toward top chassis 14) may be encompassed in sliding mechanism 114 within the broad scope of the embodiments of the present disclosure

In some embodiments, latch 112 may comprise a horizontal clasp 116 configured to clasp an axle of a wheelchair horizontally In some embodiments, latch 112 may comprise a vertical clasp 118 configured to clasp the axle of the wheelchair vertically In some embodiments (eg, as shown), latch 112 may comprise both horizontal clasp 116 and vertical clasp 118 Horizontal clasp 116 and/or vertical clasp 118 may be rotatable such that the axle can be locked and prevented from moving in the rotated position For example, horizontal clasp 116 may clasp the axle horizontally and then rotate downwards around the axle so that the wheelchair is prevented from moving up or sliding forward In another example, vertical clasp 118 may clasp the axle vertically and the rotate sideways around the axle so that the wheelchair is prevented from moving up or sliding forward

In various embodiments, actuators 12 (not shown) may control movements of top chassis 14, arm 18 and latch 112 In some embodiments, actuators 12 may permit top chassis 14 to slide up and down in a vertical direction 122 along sliding mechanism 16 Actuators 12 may also permit latch 112 to slide forward and backward in a transverse direction 124 along sliding mechanism 114 Actuators 12 may further cause arm 18 to pivot around an axis 126 allowing arm 18 to rest vertically against, or parallel to, a vertical surface 128 of top chassis 14 such that arm 18 is not protruding outward In such a configuration, arm 18 may be perpendicular a floor of the AV In some embodiments, arm 18 may not protrude through slot 11; instead, arm 18 may be affixed with a hinge or other mechanism that enables arm 18 to rotate relative to top chassis 14 In various embodiments, actuators 12 may be located inside top chassis 14, and/or bottom chassis 12 and/or between latch 112 of arm 18 according to suitable needs, such as actuator type, movement desired, ease of manufacturability, etc

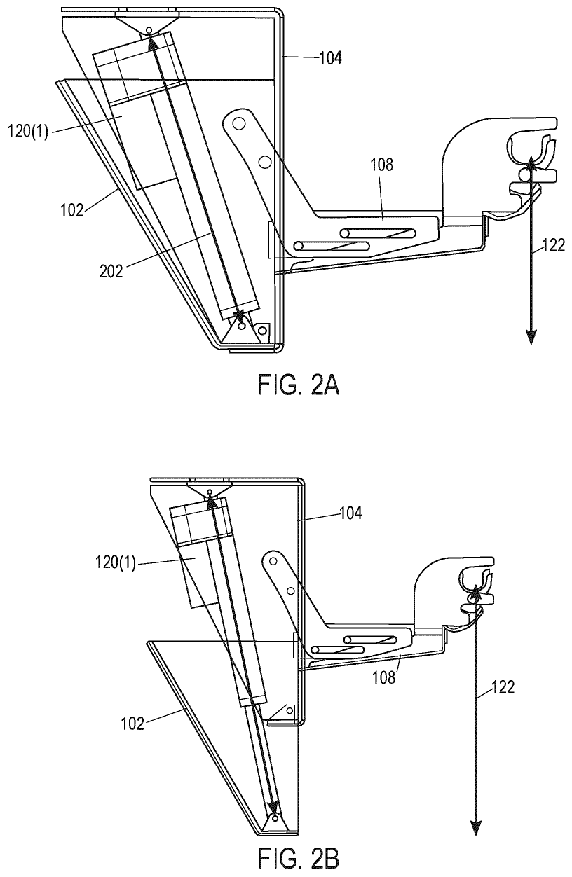

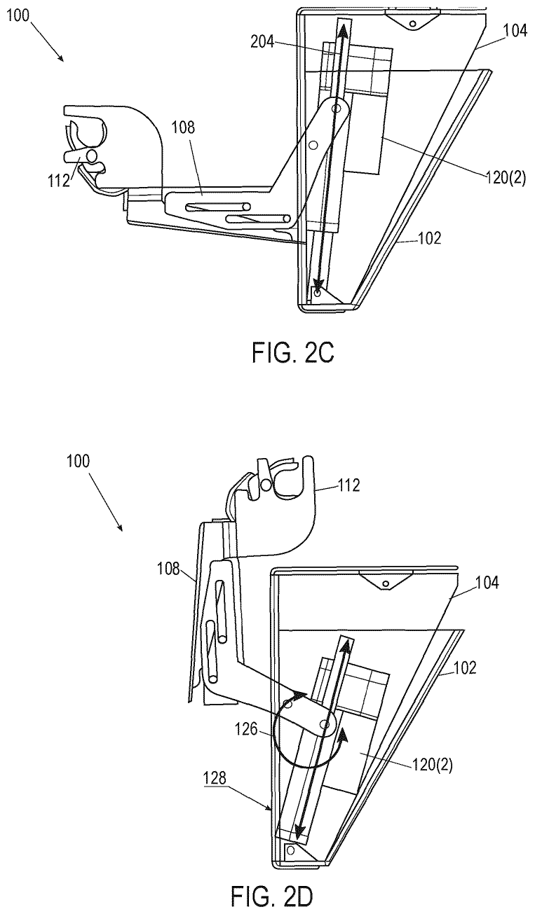

FIGS. 2A-2D illustrate operations of AUWR 1 according to an example embodiment of the present disclosure In the example embodiment shown, AUWR 1 may comprise two actuators 12(1) and 12(2), attached to and enclosed behind top chassis 14 As shown in the example embodiment of FIG. 2A, actuator 12(1) may comprise a linear actuator having two ends, one end being attached to bottom chassis 12 and another opposing end being attached to top chassis 14 When actuator 12(1) is actuated, it moves linearly up (or down) along an axis 22, causing top chassis 14 to move in a vertical direction 122 relative to bottom chassis 12, thereby raising or lowering arm 18 FIG. 2B shows actuator 12(1) in an extended position, with top chassis 14 raised relative to bottom chassis 12 In an example embodiment, when actuator 12(1) is at its lowest position as shown in FIG. 2A, a length of actuator 12(1) may be 35 mm, and latch 112 may be 196 mm vertically from the AV's floor; when actuator 12(1) is at its most extended position along axis 22 as shown in FIG. 2B, the length of actuator 12(1) may be 452 mm, and latch 112 may be 348 mm vertically from the AV's floor Note that other types of actuators may result in different travel and corresponding different heights of latch 112 Any suitable dimensions of actuator 12(1) may be used to enable securely grasping the wheelchair within the broad scope of the embodiments disclosed herein In the example embodiment shown, there is no separate sliding mechanism 16 apart from actuator 12(1), which slides along axis 22

FIGS. 2C and 2D show the operation of actuator 12(2) in the example embodiment In the example embodiment, actuator 12(2) may comprise a linear actuator with a shorter travel than actuator 12(1) Arm 18 may be attached to actuator 12(2) so that linear motion of actuator 12(2) along an axis 24 causes arm 18 to rotate (or pivot) around axis 126 from its horizontal latching position and rest vertically against, or parallel to, vertical surface 128 of top chassis 14 In an example embodiment, when AUWR 1 is deployed (eg, to secure a wheelchair) as shown in FIG. 2C, a length of actuator 12(2) may be 287 mm; when AUWR 1 is stowed as shown in FIG. 2D, the length of actuator 12(2) may be 228 mm

Although actuators 12(1) and 12(2) are described herein as linear actuators, actuators 12(1) and 12(2) may comprise any type of actuator that allows arm 18 to move vertically along direction 122 and pivot around axis 126, respectively, within the broad scope of the embodiments Further, at least some of actuators 12(1) and 12(2) shown in the figure are piston and cylinder type of linear actuators Other types of actuators suitable for the desired motion, such as servo motors that enable rotation, other types of linear actuators that enable linear motion, etc are all encompassed in actuators 12 within the broad scope of the embodiments of the present disclosure

Note that in various embodiments, bottom chassis 12 may be affixed to the AV's floor and/or frame In some embodiments, bottom chassis 12 may also be affixed along its sides and/or back to the AV's frame for added rigidity The shapes of bottom chassis 12 and top chassis 14 shown in the figure are merely for illustrative purposes and are not to be construed as limitations The shapes may vary according to the frame of the AV to which AUWR 1 is attached, forces acting on AUWR 1 during operation and transit and other considerations beyond the scope of the present disclosure

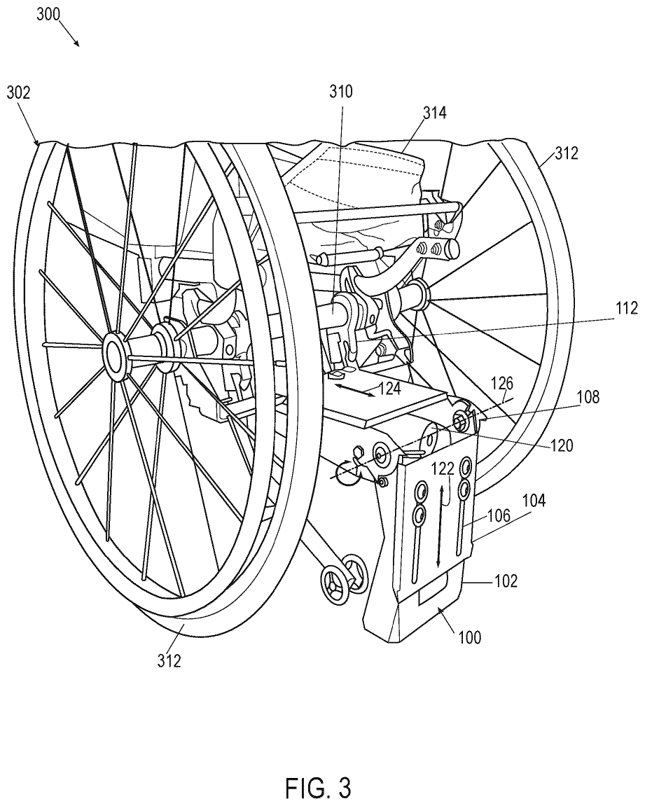

FIG. 3 illustrates a portion of an assembly 3 comprising a wheelchair 32 secured by AUWR 1 In the embodiment shown, sliding mechanism 16 that allows top chassis 14 to slide relative to bottom chassis 12 comprises pins and slots mechanism, with the slots provided in top chassis 14 and pins affixed to bottom chassis 12 Further, in the embodiment shown, arm 18 may be affixed by a rotatable hinge to top chassis 14 so that it is configured to rotate around pivot axis 126 to drop down and rest perpendicular to the vehicle floor, for example, vertically, when not in use In such an inoperative position, latch 112 may be proximate to the vehicle floor In other embodiments, arm 18 may be configured to rotate around pivot axis 126 in the opposite direction, such that when arm 18 is perpendicular to the vehicle floor in the inoperative position, latch 112 is distant from the vehicle floor

During operation, actuators 12 may cause arm 18 to rotate around pivot axis 126 from an inoperative position perpendicular to the vehicle floor to an operative position parallel to the vehicle floor Actuators 12 may cause latch 112 to extend forward (ie, away from top chassis 14 toward wheelchair 32) along transverse direction 124 (ie, parallel to the floor of the vehicle floor) to grasp an axle 31 of wheelchair 32 securely Axle 31 attaches wheels 312 of wheelchair laterally beneath seat 314 In the embodiment shown, wheelchair 32 is positioned such that AUWR 1 is between wheels 312 of wheelchair 32 Because of the downward forces acting on arm 18, AUWR 1 may not be configured to operate with an occupant in wheelchair 32 in some embodiments

The appropriate position (eg, height from vehicle floor, distance from top chassis 14, etc) of latch 112 to grip axle 31 may be obtained by a controller (not shown) which directs actuators 12 using any suitable means, for example, through electrical control signals over a wired connection In one embodiment, the owner/occupant of wheelchair 32 may answer a survey before riding that provides information to the controller about wheelchair 32, such as wheel diameter (from which the position of axle 31 may be deduced) In another embodiment, the owner/occupant of wheelchair 32 may use button controls inside the AV to adjust the position of the latches to wheelchair 32 The button controls may be provided in a remote control coupled to actuators 12 The remote control may be coupled to the controller, which then directs actuators 12 accordingly In yet another embodiment, sensors such as low-cost single plane Light Detection and Ranging (LIDAR) sensors may be used to automatically detect the position of axle 31 as wheelchair 32 moves into position proximate to AUWR 1 The sensors may provide the data to the controller, which then directs actuators 12 accordingly In yet other embodiments, a preset configuration may be stored in the controller, which directs actuators 12 according to the present configuration such that latch 112 automatically returns to the desired position on future trips without further work from the wheelchair owner/occupant In some embodiments, for example, where the wheelchair information in known prior to the wheelchair occupant entering the AV, AUWR 1 may be actuated by the controller and moved into the appropriate position for the particular wheelchair before the wheelchair occupant enters the AV

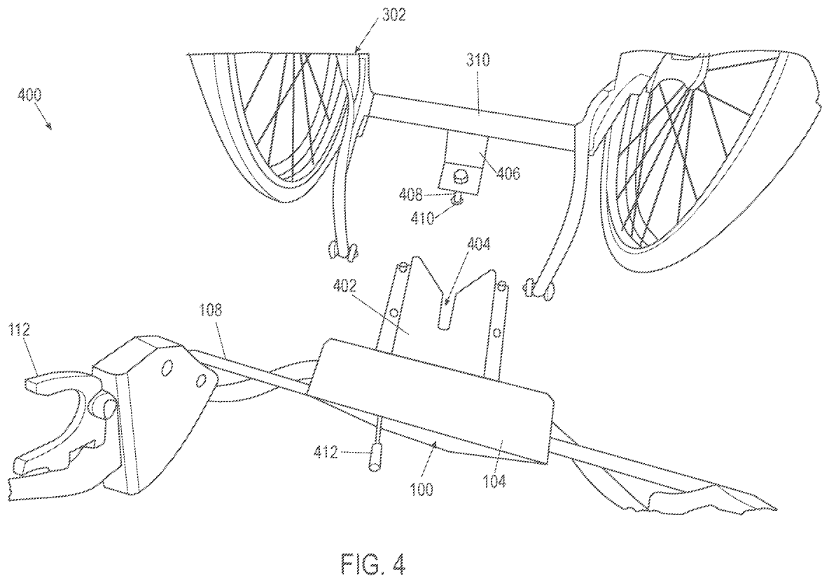

FIG. 4 illustrates an autonomous wheelchair securement system 4 comprising AUWR 1 and an OWR 42 configured to secure wheelchair 32 OWR 42 is affixed to the vehicle floor, for example, using nuts and bolts or other attachment means OWR 42 comprises a slot 44 configured to accept an adapter 46 on wheelchair 32 Adapter 46, which is affixed to wheelchair 32, comprises a pin 48 having a pinhead 41 A diameter of pin 48 may be smaller than a width of slot 44, and a diameter of pinhead 41 is greater than the width of slot 44 During securement of wheelchair 32 to OWR 42, pin 48 may slide through slot 44 because the diameter of pin 48 is smaller than the width of slot 44, but pin 48 cannot be removed vertically because the diameter of pinhead 41 is greater than width of slot 44 A latch (not shown) in OWR 42 may lock pin 48 in place to prevent sliding forward, thus securely locking wheelchair 32 in place Because there are no downward forces exerted on any member of OWR 42, wheelchair 32 may be occupied when secured

In some embodiments (eg, as shown), AUWR 1 may be placed in an inoperative position, with latch 112 in its vertical resting position when wheelchair 32 is secured to OWR 42 In such embodiments, AUWR 1 may be actuated by actuators 12 (not shown) to move to the inoperative position so that it does not interfere with securement of wheelchair 32 to OWR 42 In the embodiment shown, latch 112 may be operated by actuators directly affixed thereto Other actuators may be located within the enclosure of top chassis 14 AUWR 1 may be placed in the inoperative position in cases where the wheelchair dimensions are such that arm 18 of AUWR 1 would interfere with parts of wheelchair 32, for example, a motor (in cases where wheelchair 32 is motorized)

In some other embodiments, AUWR 1 may also be used together with OWR 1 for added security In such embodiments, during operation, AUWR 1 may be actuated by actuators 12 such that arm 18 is moved into the operative position where latch 112 may grasp axle 31 suitably The combined operation of AUWR 1 and OWR 42 may permit securement of wheelchair 32 whether or not occupied when the AV is in motion A lever 412 may be provided in AUWR 1 and/or OWR 42 to enable manual release of wheelchair 32 in the event of power failure or other emergency when actuators 12 are not operating

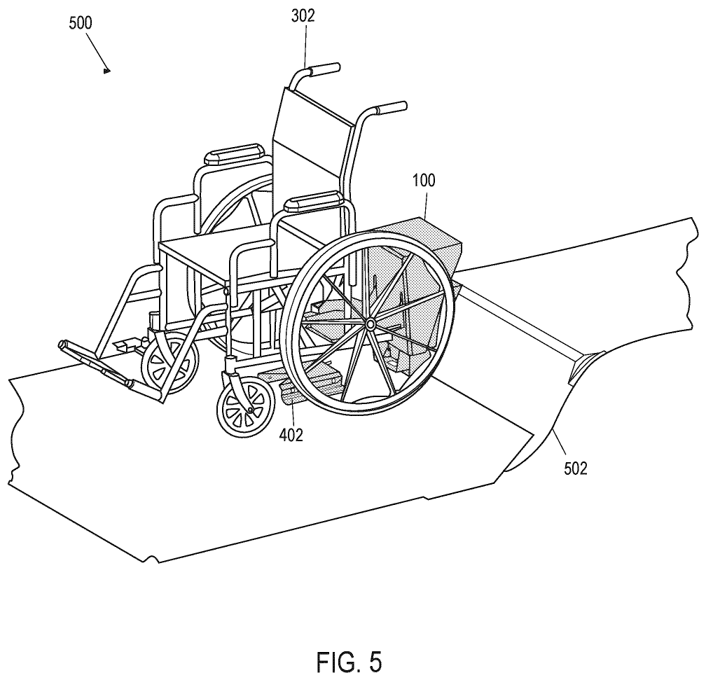

FIG. 5 illustrates an example configuration 5 with a wheelchair 32 restrained by AUWR 1 and/or by OWR 42 AUWR 1 and OWR 42 are fastened to vehicle floor 52 In various embodiments, vehicle floor 52 may be part of the chassis and/or frame of the AV In other embodiments, vehicle floor 52 may be an additional part or parts, for example, a false floor, attached to the chassis and/or frame of the AV The shape of AUWR 1 may be configured according to the shape of vehicle floor 52, for example, to enable reliable and robust attachment thereto The shape of AUWR 1 shown in the figure is merely for illustrative purposes and is not to be construed as a limitation The shape may vary according to the shape of vehicle floor 52 to which AUWR 1 is attached, forces acting on AUWR 1 during operation and transit and other considerations beyond the scope of the present disclosure

Having both AUWR 1 and OWR 42 in a space occupiable by a single wheelchair 32 may enable a compact configuration applicable to a wide variety of wheelchair makes and models, without sacrificing valuable cabin space inside the AV Such a configuration is advantageous over another configuration in which AUWR 1 and OWR 42 are placed side-by-side, for example Further with configuration 5 in which both AUWR 1 and OWR 42 are in line with each other in a space occupiable by a single wheelchair 32, three different operative modes are possible: (1) a first mode in which AUWR 1 is operational and OWR 42 is not operational; (2) a second mode in which AUWR 1 is not operational, and OWR 42 is operational; and (3) a third mode in which both AUWR 1 and OWR 42 are operational In the first and third modes, arm 18 of AUWR 1 is extended and grasps acle 31 of wheelchair 32; in the second mode, arm 18 of AUWR 1 is moved away from interfering with wheelchair 32

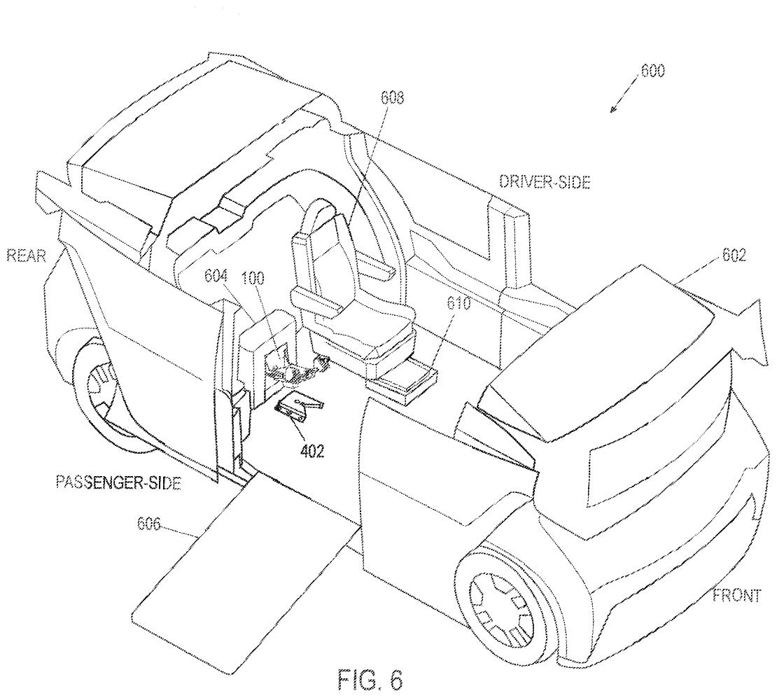

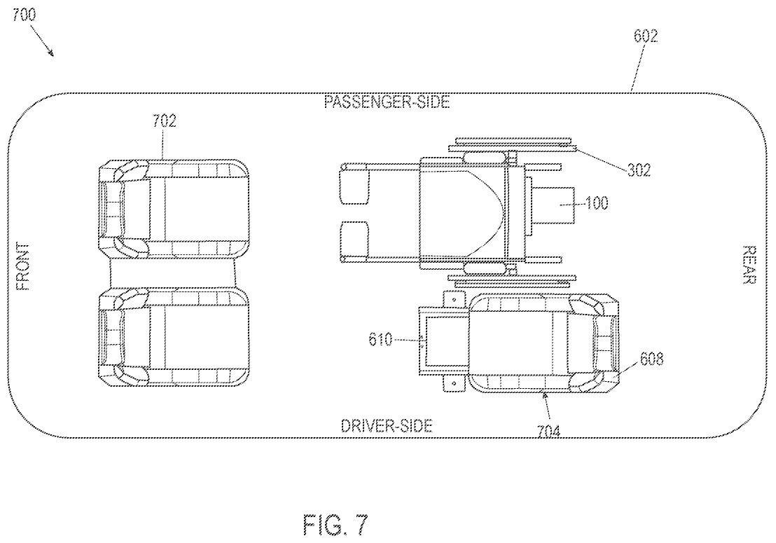

FIG. 6 illustrates an example configuration 6 with an AV 62 AV 62 is shown without its roof to enable a clearer view of the inside its main cabin AV 62 is equipped with AUWR 1 and OWR 42 on its rear passenger-side row of seats, with wheelchair 32 (not shown) facing toward the front AUWR 1 may be located wholly or partially inside an enclosure 64 that houses other electronics, for example, the controller that controls actuators 12 In the picture shown, AUWR 1 is in the extended position, ready to engage with wheelchair 32 AUWR 1, OWR 42 and enclosure 64 may be securely fastened to the chassis and/or frame of AV 62, for example, vehicle floor 52 AV 62 may also be fitted with a ramp 66 that may be extended when needed and retracted when not needed, for example, so that the doors of AV 62 can be closed Ramp 66 may enable wheelchair 32 to enter and exit AV 62 easily

AV 62 may also be configured with a transfer seat 68 alongside the space occupiable by wheelchair 32 Transfer seat 68 may be used to enable a wheelchair occupant to move thereinto and engage AUWR 1 to secure the now unoccupied wheelchair 32 In various embodiments, transfer seat 68 may be configured with a TSB 61 that enables moving transfer seat 68 forward and backward according to the dimensions of wheelchair 32 In various embodiments, AUWR 1 may be configured to raise or lower wheelchair 32 so that the seat of wheelchair 32 is in line with the seat of transfer seat 68 to enable the wheelchair occupant to move comfortably and easily to transfer seat 68

In various embodiments, AV 62 is preferably a fully autonomous automobile, but may additionally or alternatively be any semi-autonomous or fully autonomous vehicle; eg, a boat, an unmanned aerial vehicle, a self-driving car, etc Additionally, or alternatively, AV 62 may be a vehicle that switches between a semi-autonomous state and a fully autonomous state and thus, the AV may have attributes of both a semi-autonomous vehicle and a fully autonomous vehicle depending on the state of the vehicle

AV 62 may include a throttle interface that controls an engine throttle, motor speed (eg, rotational speed of electric motor), or any other movement-enabling mechanism; a brake interface that controls brakes of the AV (or any other movement-retarding mechanism); and a steering interface that controls steering of the AV (eg, by changing the angle of wheels of the AV) AV 62 may additionally or alternatively include interfaces for control of any other vehicle functions, eg, windshield wipers, headlights, turn indicators, air conditioning, etc

AV 62 includes a sensor suite, which may include a computer vision (“CV”) system, localization sensors, and driving sensors For example, the sensor suite 14 may include photodetectors, cameras, radar, sonar, lidar, GPS, wheel speed sensors, inertial measurement units (IMUS), accelerometers, microphones, strain gauges, pressure monitors, barometers, thermometers, altimeters, etc The sensors may be located in various positions in and around AV 62 For example, the sensor suite may include multiple cameras mounted at different positions on AV 62, including within the main cabin for passengers and/or deliveries

An onboard computer may be connected to the sensor suite and functions to control AV 62 and to process sensed data from the sensor suite and/or other sensors in order to determine the state of AV 62 Based upon the vehicle state and programmed instructions, the onboard computer modifies or controls behavior of AV 62 In addition, the onboard computer may provide instructions and/or data to the controller that controls actuators 12 of AUWR 1 and other AV components used for wheelchair securement, including movement of ramp 66, and transfer seat 68

FIG. 7 illustrates a simplified diagram of a main cabin 7 in AV 62 Main cabin 7 includes at least two rows of seats In an example embodiment, a first row 72 comprises two rear-facing passenger seats A second row 74 comprises the space for wheelchair 32, including AUWR 1 and OWR 42 (not shown) and transfer seat 68 on TSB 61 Transfer seat 68 and wheelchair 32 are front-facing, positioned toward the rear of AV 62 in some embodiments Such a position in the rear, facing forward to the front of AV 62, allows AUWR 1 to be attached securely to vehicle floor 52 of AV 62 while permitting wheelchair 32 to face other passenger seats in main cabin 7 In some embodiments, the space for wheelchair 32 may be located proximate to the passenger-side, mainly for safety and ease of getting on and off AV 62 using ramp 66 (not shown) from a curb In some embodiments where safety getting in and out of AV 62 from the driver-side is not of concern (eg, in the case of an AV boat docked at a pier), ramp 66 may be provided on both sides or on the driver-side, and the space for wheelchair 32 may be located on the driver-side proximate to ramp 66

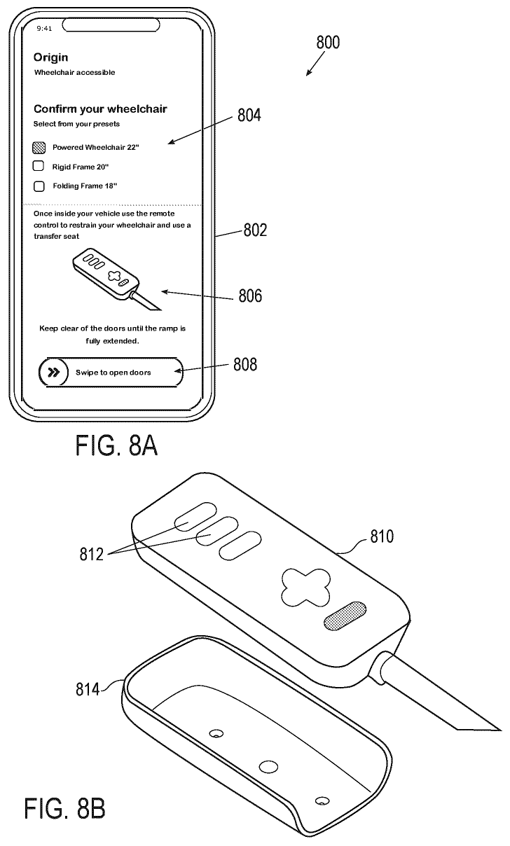

FIG. 8A illustrates an example user interface of an application software (“app”) 8 executing in an electronic device 82 In the embodiment shown, electronic device 82 comprises a phone In other embodiments, electronic device 82 may comprise a laptop, tablet computer, or other such device configured to execute apps suitably App 8 may comprise a configuration portion 84 enabling a user to input wheelchair dimensions, make, model, etc In some embodiments, options presented to the user in configuration portion 84 may be preset, for example, among a few choices In other embodiments, configuration portion 84 may permit the user to input configuration information freely without being restrained to a few choices In yet other embodiments, configuration portion 84 may present options previously saved for that user, for example, based on a previous ride and/or booking In many embodiments, the user may input the configuration information during a booking of the vehicle for ride-share purposes and these options may be presented again for confirmation in configuration portion 84 when the vehicle is ready to be boarded Any suitable means to enter configuration information of wheelchair 32 may be encompassed in configuration portion 84 within the broad scope of the embodiments of the present disclosure

App 8 may also comprise an instruction portion 86 that provides specific instructions on using the securement device inside the AV App 8 may further comprise a command portion 88 that allows the user to directly control operations of the wheelchair securement system, including the doors of AV 62, ramp 66, AUWR 1, OWR 42, and TSB 61 (among other components)

FIG. 8B illustrates a remote control 81 used in conjunction with app 8 for operating the wheelchair securement system in AV 62 In some embodiments, instructions for operating remote control 81 may be provided in app 8 In other embodiments, remote control 81 may be operated intuitively, for example, according to control buttons 812 presented on remote control 81 In some embodiments, remote control 81 may be coupled with a wired connection to the wheelchair securement system; in other embodiments, remote control 81 may communicate wirelessly with the wheelchair securement system In many embodiments, a protective holder 814 attached within AV 62, for example, to transfer seat 68, may be provided to hold remote control 81 when not in use The user may update movements of the wheelchair securement system, including ramp 66, AUWR 1 and/or OWR 42 using remote control 81 For example, buttons 812 may include options to lock AUWR 1 and/or OWR 42, unlock AUWR 1 and/or OWR 42, move arm 18 and/or latch 112 of AUWR 1 up or down, forward or backward, etc

In some embodiments, remote control 81 may include buttons 812 to control TSB 61 in addition to AUWR 1 and/or OWR 42 For example, suitable buttons 812 may permit the user to move transfer seat 68 forward, backward, up, down, left, or right as needed to align with wheelchair 32 so that the wheelchair occupant can comfortably and safely move from wheelchair 32 to transfer seat 68 In some embodiments one of buttons 812 may comprise a “home” position that permits the wheelchair securement system, including ramp 66, TSB 61, AUWR 1 and/or OWR 42 to return to their default positions In some embodiments, a light emitting diode (LED) indicator may signal when the wheelchair restraint system is safe to use, unlocked, locked, etc

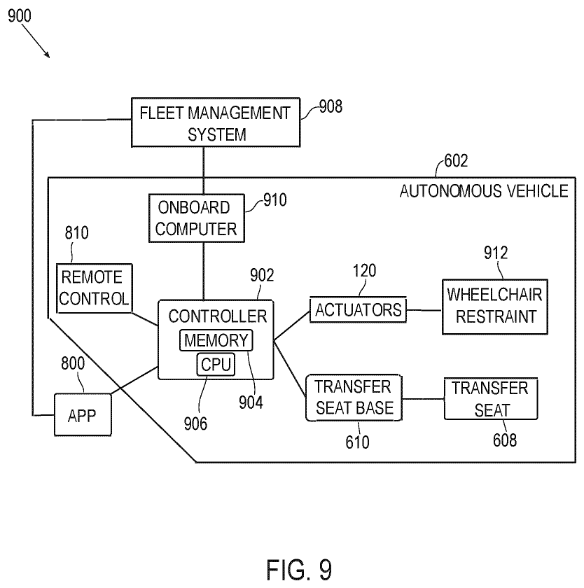

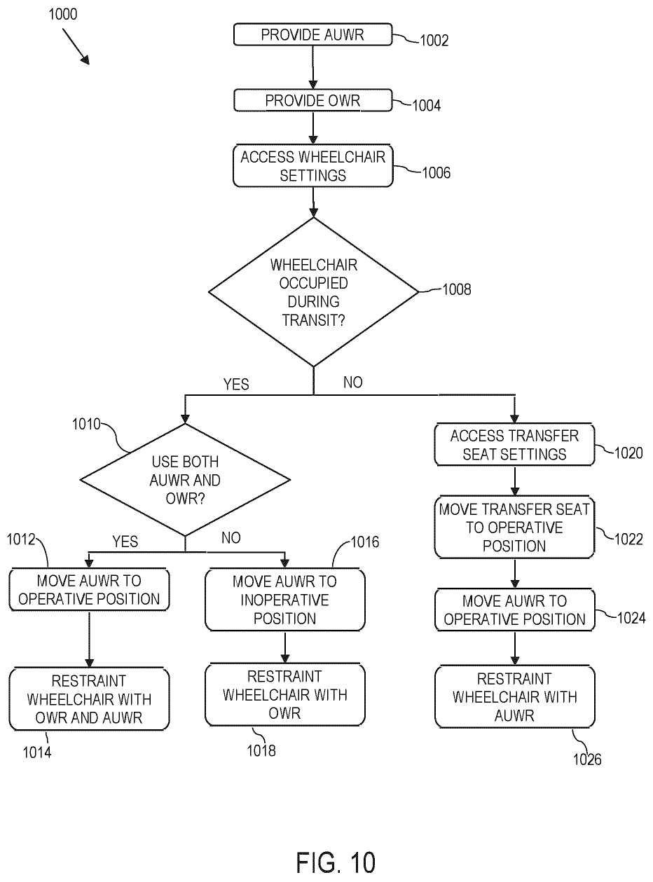

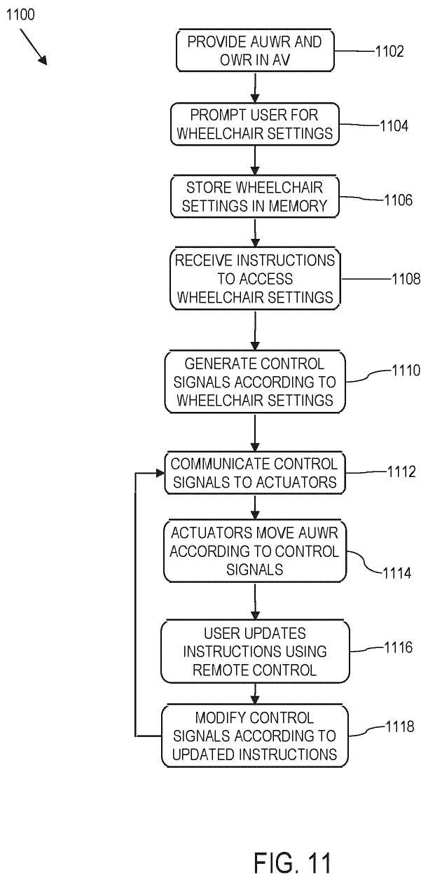

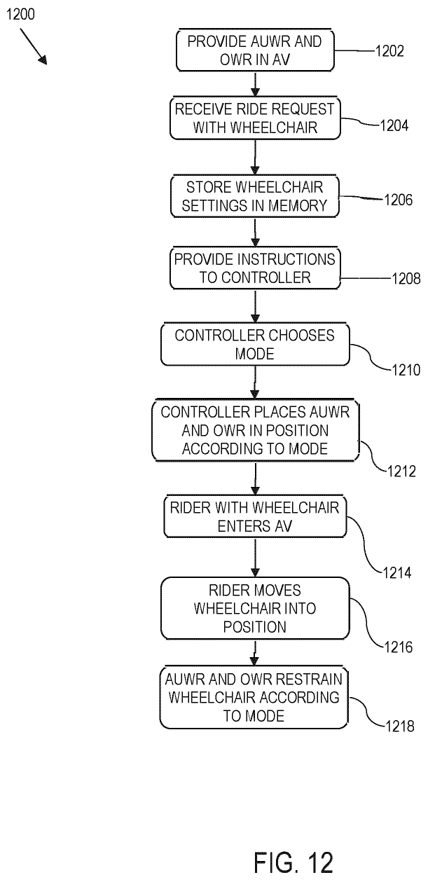

FIG. 9 is a simplified block diagram of a wheelchair securement system 9 according to various embodiments of the present disclosure Wheelchair securement system 9 comprises a controller 92 in AV 62 having a memory 94 and a processor 96, for example, a central processing unit (CPU) In various embodiments, controller 92 comprises electrical and electronic circuits, including microprocessors, microcontrollers, interfaces, and/or other components known in the art to function together to receive request signals, generate control signals, and communicate the generated control signals to appropriate elements For example, controller 92 may comprise a comparative device that receives a value (eg, of a process variable) in an input electrical signal, compares the value with that of a predetermined control point value (eg, set point) stored in memory 94, and determines an appropriate amount of output signal configured to provide corrective action within a control loop, for example, using digital algorithms by processor 96

App 8 outside AV 62 and remote control 81 inside AV 62 may communicate with controller 92 suitably For example, app 8 may communicate with controller 92 directly by wireless means in some embodiments In other embodiments, app 8 may communicate with a fleet management system 98, which in turn communicates with an onboard computer 91 in AV 62, which in turn communicates with controller 92 In some embodiments, onboard computer 91 may communicate with controller 92 without any directions or instructions from fleet management system 98, for example, in situations where instructions to operate controller 92 are provided (eg, saved) locally in onboard computer 91

Onboard computer 91 may be connected to the sensor suite in AV 62 and functions to control AV 62 and to process sensed data from the sensor suite and/or other sensors in order to determine the state of AV 62 and the wheelchair securement system in AV 62 Based upon the vehicle state and programmed instructions, onboard computer 91 modifies or controls behavior of AV 62 and wheelchair securement system in AV 62 In addition, onboard computer 91 may provide instructions and/or data to controller 92 and other AV components, including ramp 66, and transfer seat 68

Onboard computer 91 is a general-purpose computer adapted for I/O communication with vehicle control systems and the sensor suite but may additionally or alternatively be any suitable computing device In some embodiments, onboard computer 91 is connected to the Internet via a wireless connection (eg, via a cellular data connection) Additionally or alternatively, onboard computer 91 may be coupled to any number of wireless or wired communication systems

Fleet management system 98 manages a fleet of AVs, including AV 62 Fleet management system 98 may manage one or more services that provide or use the AVs, eg, a service for providing rides to users with wheelchairs Fleet management system 98 may select an AV from the fleet of AVs to perform a particular service or other task and instruct the selected AV to autonomously drive to a particular location (eg, a delivery address) Fleet management system 98 may select a route for AV 62 to follow Fleet management system 98 may also manage fleet maintenance tasks, such as charging, servicing, and cleaning of the AV AV 62 communicates with the fleet management system using wireless means, for example, over a public network, such as the Internet Fleet management system 98 may further enable AUWR 1 to position arm 18 and latch 112 to be compatible with wheelchair 32 of a prospective rider before the rider enters AV 62

Controller 92 may operate actuators 12 and TSB 61 using available instructions, for example, obtained through app 8, or remote control 81, or onboard computer 91 In some embodiments, the instructions may be stored locally in memory 94 in controller 92 In some embodiments, wheelchair presets (eg, configuration information) may also be stored in memory 94 CPU 96 may execute the instructions or generate instructions according to the wheelchair presets in memory 94 suitably and execute them appropriately to generate instructions, for example, electrical control signals Actuators 12 may operate elements of wheelchair restraint 912 according to the instructions from controller 92

Wheelchair restraint 912 comprises AUWR 1 and OWR 42 in many embodiments Actuators 12 may control movement of arm, latches, chassis and locks in AUWR 1 and OWR 42 suitably, according to instructions from controller 92 TSB 61 may operate transfer seat 68 suitably according to instructions from controller 92 The instructions may comprise, for example, the distance to move forward (or backward) and the height to raise or lower transfer seat 68 to be aligned with the user's wheelchair In some embodiments, controller 92 may comprise separate controllers for actuators 12 and TSB 61 In other embodiments controller 92 may operate both actuators 12 and TSB 61 suitably

### Example Methods

FIG. 1 is a simplified flow diagram illustrating various operations 1 that may be associated with wheelchair securement system 9 according to embodiments of the present disclosure At 12, AUWR 1 may be provided At 14, OWR 42 may be provided At 16, wheelchair settings (eg, wheelchair make, model, dimensions, etc) of wheelchair 32 may be accessed by controller 92 At 18, a determination may be made whether wheelchair 32 will be occupied during transit The determination may be made based on user inputs in app 8 in some embodiments In other embodiments, the determination may be made based on user inputs through remote control 81 In yet other embodiments, the determination may be made based on user behavior and/or settings in previous rides, such information being retrieved from onboard computer 91 or otherwise stored in memory 94 of controller 92

If wheelchair 32 will be occupied during transit, the operations step to 11, at which another determination may be made whether to use both AUWR 1 and OWR 42 The determination may be made based on the wheelchair settings, for example, dimensions, components, etc that would permit controller 92 to conclude that AUWR 1 can latch onto axle 31 of wheelchair 32 without interference from other parts of the wheelchair If the determination is made that both AUWR 1 and OWR 42 are to be used, the operations step to 112, at which AUWR 1 is moved into an operative position, for example, with arm 19 and latch 112 at the right position and location to latch onto axle 31 of wheelchair 32 when placed proximate to AUWR 1 At 114, wheelchair 32 may be restrained with AUWR 1 and OWR 42 suitably If, at 11, the determination is made that both AUWR 1 and OWR 42 are not to be used, the operations step to 116, at which AUWR 1 is moved into an inoperative position, for example, with arm 18 and latch 112 away from wheelchair 32 (eg, perpendicular to vehicle floor 52) In many embodiments, OWR 42 may also be simultaneously unlocked to enable it to couple to adapter 46 At 118, wheelchair 32 is restrained with OWR 42 using adapter 46

If at 18, the determination is made that wheelchair 32 will not be occupied during transit, the operations step to 12, at which controller 92 may access the transfer seat settings, for example, from memory 94 or onboard computer 91 At 122, controller 92 may instruct TSB 61 to move transfer seat 68 to an operative position, for example, aligned suitably with wheelchair 32 At 124, AUWR 1 is moved to the operative position, with arm 18 and latch 112 at the right position and location to latch onto axle 31 of wheelchair 32 when placed proximate to AUWR 1 At 126, wheelchair 32 is restrained with AUWR 1 suitably

FIG. 11 is a simplified flow diagram illustrating various operations 11 that may be associated with wheelchair securement system 9 according to embodiments of the present disclosure At 112, AUWR 1 and OWR 42 may be provided in AV 62 At 114, the user (eg, wheelchair occupant, rider, etc who uses app 8 or avails the ride-sharing services managed by fleet management system 98) may be promoted for wheelchair settings In some embodiments, this prompting may be performed through the user interface of app 8 In other embodiments, this prompting may be performed through other means, for example, the ride-sharing software used by fleet management system 98 At 116, the user input wheelchair settings may be stored in memory In some embodiments, the memory storing the wheelchair settings may be located in devices associated with fleet management system 98 In other embodiments, the memory storing the wheelchair settings may be located in onboard computer 91 In yet other embodiments, the memory storing the wheelchair settings may comprise memory 94 of controller 92

At 118, instructions may be received to access wheelchair settings In some embodiments, the instructions may be received at onboard computer 91, for example, when AV 62 is made ready for the ride requested by the wheelchair user In other embodiments, the instructions made be received at controller 92, for example, when AV 62 is at the pickup location of the wheelchair user and wheelchair restraints 912 is to be made ready to receive wheelchair 32 At 111, controller 92 may generate control signals according to the wheelchair settings accessed and retrieved from memory At 1112, controller 92 may communicate the control signals to actuators 12 At 1114, actuators 12 may move AUWR 1 (and unlock OWR 42 as needed) according to control signals received from controller 92 At 1116, the user may update instructions using remote control 81 For example, the user may want to move to transfer seat 68 At 1118, controller 92 may modify control signals according to the updated instructions The operations loop back to 1112 with the modified control signals and continue until the user is satisfied and the wheelchair is secured

FIG. 12 is a simplified flow diagram illustrating various operations 12 that may be associated with wheelchair securement system 9 according to embodiments of the present disclosure At 122, AUWR 1 and OWR 1 may be provided in AV 62 At 124, a ride request with wheelchair may be received at fleet management system 98 At 126, the rider's wheelchair settings are obtained and stored in memory suitably At 128, instructions are provided to controller 92 At 121, controller 92 chooses mode of operation from among three modes: a first mode in which wheelchair 32 is not occupied and AUWR 1 alone is used to restrain wheelchair 32; a second mode in which wheelchair 32 is occupied and/or otherwise fitted with adapter 46 and OWR 42 alone is used to restrain wheelchair 32; and a third mode in which wheelchair 32 is occupied and/or otherwise fitter with adapter 46 and both AUWR 1 and OWR 42 are used to restrain wheelchair 32 The selection may be made based on user inputs about ride preferences, wheelchair dimensions, make, model, etc

At 1212, controller 92 places AUWR 1 and OWR 42 in position (eg, operative position or inoperative position; locked or unlocked) according to the selected mode At 1214, the rider with wheelchair 32 enters AV 62 At 1216, the rider moves wheelchair 32 into position proximate to AUWR 1 and OWR 42 At 1218, AUWR 1 and/or OWR 42 restrain wheelchair 32 according to the selected mode

Although FIGS. 1-12 illustrate various operations performed in a particular order, this is simply illustrative, and the operations discussed herein may be reordered and/or repeated as suitable For example, one or more operations may be performed in parallel to secure wheelchair 32 and align transfer seat 68 substantially simultaneously In another example, the operations may be performed in a different order to reflect the preferences of a particular user Numerous other variations are also possible to achieve the desired wheelchair securement Further, additional processes which are not illustrated may also be performed without departing from the scope of the present disclosure For example, the operations may include various data accessing operations, instructions generations, execution of instructions, movement of actuators and/or other elements of the system

### SELECT EXAMPLES

Example 1 provides a wheelchair securement system for a vehicle comprising: a first wheelchair restraint comprising a latch configured to grasp an axle of a wheelchair; a second wheelchair restraint comprising a mechanism to securely couple with an adapter on the wheelchair; and a controller configured to select from among one of three selections: a first mode of securing the wheelchair with the first wheelchair restraint alone; a second mode of securing the wheelchair with the second wheelchair restraint alone; and a third mode of securing the wheelchair using both the first wheelchair restraint and the second wheelchair restraint
Example 2 provides the wheelchair securement system of example 1, in which the first wheelchair restraint comprises actuators, and the controller generates control signals that control movement of the actuators according to the selected one of the three selections
Example 3 provides the wheelchair securement system of example 1, in which the first wheelchair restraint cannot be used alone to secure an occupied wheelchair
Example 4 provides the wheelchair securement system of example 1, in which the second wheelchair restraint is configured to secure an occupied wheelchair
Example 5 provides the wheelchair securement system of example 1, in which the first mode comprises placing the first wheelchair restraint in an operative position before the wheelchair enters the vehicle The operative position comprises positioning the latch at a location where the axle of the wheelchair can be grasped securely
Example 6 provides the wheelchair securement system of example 1, in which the second mode comprises placing the first wheelchair restraint in an inoperative position before the wheelchair enters the vehicle The inoperative position comprises positioning the latch away from the wheelchair
Example 7 provides the wheelchair securement system of example 1, in which the third mode comprises, before the wheelchair enters the vehicle: placing the first wheelchair restraint in an operative position, comprising positioning the latch at a location where the axle of the wheelchair can be grasped securely; and unlocking the second wheelchair restraint such that it is ready to secure the adapter
Example 8 provides the wheelchair securement system of example 1, further comprising a remote control in communication with the controller, in which operations on the remote control provide instructions to the controller for selecting between the three selections
Example 9 provides the wheelchair securement system of example 1, further comprising an application software executing in an electronic device, in which the application software provides instructions to the controller for selecting between the three selections
Example 1 provides the wheelchair securement system of example 1, in which the first wheelchair restraint and the second wheelchair restraint are located at a front-facing rear passenger-side of the vehicle
Example 11 provides a wheelchair restraint for a vehicle comprising: a bottom chassis securely fastened to a floor of the vehicle; a top chassis configured to slide up and down relative to the bottom chassis; an arm configured to rotate around a pivot axis at a first end proximate to the top chassis; a latch configured to securely grasp an axle of a wheelchair, the latch being attached to a second end of the arm distant from the top chassis and configured to slide relative to the arm toward and away from the top chassis; a first actuator configured to slide the top chassis relative to the bottom chassis; a second actuator configured to rotate the arm around the pivot axis; and a third actuator configured to slide the latch relative to the arm
Example 12 provides the wheelchair restraint of example 11, in which the latch comprises a horizontal clasp and a vertical clasp and the wheelchair restraint further comprises a fourth actuator configured to move the horizontal clasp and the vertical clasp to securely grasp the axle of the wheelchair
Example 13 provides the wheelchair restraint of example 11, in which the first actuator, the second actuator, and the third actuator are controlled by a controller according to preset configuration settings of the wheelchair
Example 14 provides the wheelchair restraint of example 11, in which the top chassis slides relative to the bottom chassis using a sliding mechanism comprising rails
Example 15 provides the wheelchair restraint of example 11, in which the top chassis slides relative to the bottom chassis using a sliding mechanism comprising slots and pins
Example 16 provides a controller for a wheelchair securement system, the controller comprising: a memory configured to store preset configuration settings of a wheelchair; and a processor configured to generate a set of instructions for an actuator of a wheelchair restraint in an AV The wheelchair restraint is configured to secure the wheelchair during motion of the AV
Example 17 provides the controller of example 16, in which the preset configuration settings are received from an onboard computer in the AV
Example 18 provides the controller of example 16, in which the set of instructions control the actuator to move the wheelchair restraint from a first operative position to a second operative position according to a selection from among one of three choices: a first mode of securing the wheelchair comprising placing the wheelchair restraint in the first operative position; a second mode of securing the wheelchair comprising placing the wheelchair restraint in the second operative position and unlocking another wheelchair restraint; and a third mode of securing the wheelchair comprising placing the wheelchair restraint in the first operative position and unlocking the another wheelchair restraint
Example 19 provides the controller of example 16, in which the processor is further configured to generate another set of instructions for a TSB in the AV, the TSB configured to move a transfer seat forward and backward according to the another set of instructions
Example 20 provides the controller of example 16, in which the controller is configured to communicate with a remote control and an application software executing in an electronic device separate from the controller

### OTHER IMPLEMENTATION NOTES, VARIATIONS, AND APPLICATIONS

It is to be understood that not necessarily all objects or advantages may be achieved in accordance with any particular embodiment described herein Thus, for example, those skilled in the art will recognize that certain embodiments may be configured to operate in a manner that achieves or optimizes one advantage or group of advantages as taught herein without necessarily achieving other objects or advantages as may be taught or suggested herein

In one example embodiment, any number of electrical circuits of the figures may be implemented on a board of an associated electronic device The board can be a general circuit board that can hold various components of the internal electronic system of the electronic device and, further, provide connectors for other peripherals More specifically, the board can provide the electrical connections by which the other components of the system can communicate electrically Any suitable processors (inclusive of digital signal processors, microprocessors, supporting chipsets, etc), computer-readable non-transitory memory elements, etc can be suitably coupled to the board based on particular configuration needs, processing demands, computer designs, etc Other components such as external storage, additional sensors, controllers for audio/video display, and peripheral devices may be attached to the board as plug-in cards, via cables, or integrated into the board itself In various embodiments, the functionalities described herein may be implemented in emulation form as software or firmware running within one or more configurable (eg, programmable) elements arranged in a structure that supports these functions The software or firmware providing the emulation may be provided on non-transitory computer-readable storage medium comprising instructions to allow a processor to carry out those functionalities

It is also imperative to note that all of the specifications, dimensions, and relationships outlined herein (eg, the number of processors, logic operations, etc) have only been offered for purposes of example and teaching only Such information may be varied considerably without departing from the spirit of the present disclosure, or the scope of the appended claims The specifications apply only to one non-limiting example and, accordingly, they should be construed as such In the foregoing description, example embodiments have been described with reference to particular arrangements of components Various modifications and changes may be made to such embodiments without departing from the scope of the appended claims The description and drawings are, accordingly, to be regarded in an illustrative rather than in a restrictive sense

Note that with the numerous examples provided herein, interaction may be described in terms of two, three, four, or more components However, this has been done for purposes of clarity and example only It should be appreciated that the system can be consolidated in any suitable manner Along similar design alternatives, any of the illustrated components, modules, and elements of the FIGURES may be combined in various possible configurations, all of which are clearly within the broad scope of this Specification

Note that in this Specification, references to various features (eg, elements, structures, modules, components, steps, operations, characteristics, etc) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments

Numerous other changes, substitutions, variations, alterations, and modifications may be ascertained to one skilled in the art and it is intended that the present disclosure encompass all such changes, substitutions, variations, alterations, and modifications as falling within the scope of the appended claims Note that all optional features of the systems and methods described above may also be implemented with respect to the methods or systems described herein and specifics in the examples may be used anywhere in one or more embodiments

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 USC § 112 as it exists on the date of the filing hereof unless the words “means for” or “step for” are specifically used in the particular claims; and (b) does not intend, by any statement in the Specification, to limit this disclosure in any way that is not otherwise reflected in the appended claims

1. A wheelchair securement system for a vehicle comprising:
a latch configured to grasp an axle of a wheelchair;
actuators operatively coupled to the latch; and
a controller configured to generate control signals that control movement of the actuators to place the latch in an operative position before the wheelchair enters the vehicle, the operative position comprising a location where the axle of the wheelchair can be grasped securely.

2. The wheelchair securement system of claim 1, further comprising a remote control in communication with the controller, wherein operations on the remote control provide instructions to the controller for generating the control signals.

3. The wheelchair securement system of claim 1, further comprising an application software executing in an electronic device, wherein the application software provides instructions to the controller for generating the control signals.

4. The wheelchair securement system of claim 1, wherein the latch is located at a front-facing rear passenger-side of the vehicle.

5. A wheelchair restraint for a vehicle comprising:
a bottom chassis securely fastened to a floor of the vehicle;
a top chassis configured to slide up and down relative to the bottom chassis;
an arm configured to rotate around a pivot axis at a first end proximate to the top chassis;
a latch configured to securely grasp an axle of a wheelchair, the latch being attached to a second end of the arm distant from the top chassis and configured to slide relative to the arm toward and away from the top chassis;
a first actuator configured to slide the top chassis relative to the bottom chassis;
a second actuator configured to rotate the arm around the pivot axis; and
a third actuator configured to slide the latch relative to the arm.

6. The wheelchair restraint of claim 5, wherein the latch comprises a horizontal clasp and a vertical clasp and the wheelchair restraint further comprises a fourth actuator configured to move the horizontal clasp and the vertical clasp to securely grasp the axle of the wheelchair.

7. The wheelchair restraint of claim 5, wherein the first actuator, the second actuator, and the third actuator are controlled by a controller according to preset configuration settings of the wheelchair.

8. The wheelchair restraint of claim 5, wherein the top chassis slides relative to the bottom chassis using a sliding mechanism comprising rails.

9. The wheelchair restraint of claim 5, wherein the top chassis slides relative to the bottom chassis using a sliding mechanism comprising slots and pins.

10. A method for securing a wheelchair in a vehicle, the method comprising:
receiving wheelchair settings of a wheelchair to be secured in a vehicle;
generating control signals according to the wheelchair settings;
communicating the control signals to an actuator of a wheelchair restraint, wherein the actuator moves the wheelchair restraint to secure the wheelchair according to the control signals.

11. The method of claim 10, further comprising
prompting a user for the wheelchair settings.

12. The method of claim 11, wherein
the prompting is through an application software installed in an electronic device.

13. The method of claim 11, wherein
the prompting is through a remote control coupled to a controller in the vehicle.

14. The method of claim 10, further comprising
storing the wheelchair settings in a memory.

15. The method of claim 14, wherein
the memory is associated with a controller that generates the control signals based on the wheelchair settings stored in the memory.

16. The method of claim 14, wherein
the memory is associated with an onboard computer in the vehicle, and the method further comprises communicating the wheelchair settings stored in the memory of the onboard computer to a controller that generates the control signals.

17. The method of claim 14, further comprising
modifying the control signals according to updated instructions received from a remote control in the vehicle coupled to the controller.

18. The method of claim 10, wherein
the wheelchair restraint comprises:
a bottom chassis securely fastened to a floor of the vehicle;
a top chassis configured to slide up and down relative to the bottom chassis;
an arm configured to rotate around a pivot axis at a first end proximate to the top chassis;
a latch configured to securely grasp an axle of a wheelchair, the latch being attached to a second end of the arm distant from the top chassis and configured to slide relative to the arm toward and away from the top chassis.

19. The method of claim 18, wherein
the actuator comprises:
a first actuator configured to slide the top chassis relative to the bottom chassis;
a second actuator configured to rotate the arm around the pivot axis; and
a third actuator configured to slide the latch relative to the arm.
